(19) United States
(12) Patent Application Publication
(10) Pub. No.: US 2009/0119475 A1
(43) Pub. Date: May 7, 2009

(54) TIME BASED PRIORITY MODULUS FOR SECURITY CHALLENGES

(75) Inventors: Sebastian Lange, Seattle, WA (US); Victor Tan, Seattle, WA (US); Adam G. Poulos, Bothell, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/016,937

(22) Filed: Jan. 18, 2008

Related U.S. Application Data
(60) Provisional application No. 60/984,692, filed on Nov. 1, 2007.

(51) Int. Cl. G06F 12/00

(52) U.S. Cl. 711/173; 711/E12.002

(57) ABSTRACT

Systems, methods, and computer readable media are disclosed for making dictionary based attacks difficult and/or time consuming for attackers. In one example embodiment, this can be accomplished by equipping a security service with software and/or circuitry operable to select security questions from different partitions of a question table.

### CROSS-REFERENCE TO RELATED APPLICATIONS

This application claims priority to Application No. 60/984,692 filed Nov. 1, 2007 (Attorney docket number MSFT-6007), the contents of which are herein incorporated by reference in their entirety.

### BACKGROUND

In security schemes a device attempting to access a service can be challenged and only if the device replies with the correct response, will it be allowed to access the service. In some schemes a username and password are the only credentials used to validate a user of the device; however in more secure systems the challenger may ask the devices one or more questions. If the devices answer the question(s) correctly, then the challenger will allow the devices to access a service. These schemes usually only include a finite set of questions and since the set of challenge questions is finite, a dictionary attack may be a successful way to overcome this scheme. For example, since the probability that a challenge question will be reused at some point is high there is a chance that an attacker could figure out the correct response to that question with enough time and wait for the security system to ask the question again to gain access to the service. This chance is increased when multiple attackers with powerful computer systems try to collect the entire set of security questions. For example, attackers could collect the entire question space in a short amount of time by working together to build a dictionary of possible questions soon after a product or service is made accessible to the public. The attackers can monitor the protocol used by the device, or service, to communicate with a security system during the challenging process, and/or monitor how correct answers are processed by the CPU to figure out some, or all of the answers to the challenge questions. At some point after the dictionary of questions is complete, or at least a substantial portion is, the attackers could release a product that can fool the security system and people could gain unauthorized access to the service.

Generally in computing systems an implementer may desire that the number of possible questions to be infinite, however in certain instances, such as the instance where a security system is challenging a disk, a device, or a user, there may only be a limited amount of questions that can be asked due to limitations such as memory limits on the amount of space that is devoted to storing questions and answers, or fact that a disk only contains a limited amount of physical or logical properties, and the like. Thus, unless there are mechanisms in place to prevent all of the questions from being asked, an attacker with a powerful computer can process the entire question set with little or no trouble. Since an implementer may want to prevent this, there is a need to develop various techniques that can be used to make collecting an entire dictionary of questions that a security service may use difficult and time consuming.

### SUMMARY

In an example embodiment of the present disclosure, a computer readable storage medium is provided that includes, but is not limited to instructions for selecting an initial partition in a question set in accordance with a parameter; instructions for selecting a final partition in the question set in accordance with a randomizing variable and the initially selected partition; instructions for challenging a computing component with a question selected from the final partition. In addition to the foregoing, other aspects are described in the claims, drawings, and text forming a part of the present disclosure.

In an example embodiment of the present disclosure, a computing system is provided that includes, but is not limited to, an optical disk drive operable to receive a disk; a memory location operable to store a question set, the question set partitioned into a plurality of groups; a processor configured to select an initial question group from the plurality of available groups in accordance with a length of time the question set has been stored in memory; the processor further configured to use randomizing criteria on the selected initial question group to select a final question group; the processor further configured to select a question related to a property of the disk from the final group; and the processor further configured to determine whether the disk includes the property. In addition to the foregoing, other aspects are described in the claims, drawings, and text forming a part of the present disclosure.

In an example embodiment of the present disclosure, a method provided that includes, but is not limited to, receiving, by a device, a disk; accessing a table of available question partitions from a question set; using a first criteria to select an initial question partition from the available question partitions; wherein the criteria is related to a length of time the question set has been stored on the device; the processor further configured to use randomizing criteria on the selected initial question group to select a final question group; the processor further configured to select a question related to a property of the disk from the final group; and the processor further configured to determine whether the disk includes the property. In addition to the foregoing, other aspects are described in the claims, drawings, and text forming a part of the present disclosure.

It can be appreciated by one of skill in the art that one or more various aspects of the disclosure may include but are not limited to circuitry and/or programming for effecting the herein-referenced aspects; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts an example computer system wherein aspects of the present disclosure can be implemented.

FIG. 2 depicts an example operational environment for describing aspects of the present disclosure.

FIG. 3 depicts an example high level operational environment for practicing aspects of the present disclosure.

FIG. 4 depicts an example question table that can be used by a security service 210 in aspects of the present disclosure.

FIG. 5 depicts an example operational flow chart depicting operational procedures of the present disclosure.

### DETAILED DESCRIPTION OF ILLUSTRATIVE EMBODIMENTS

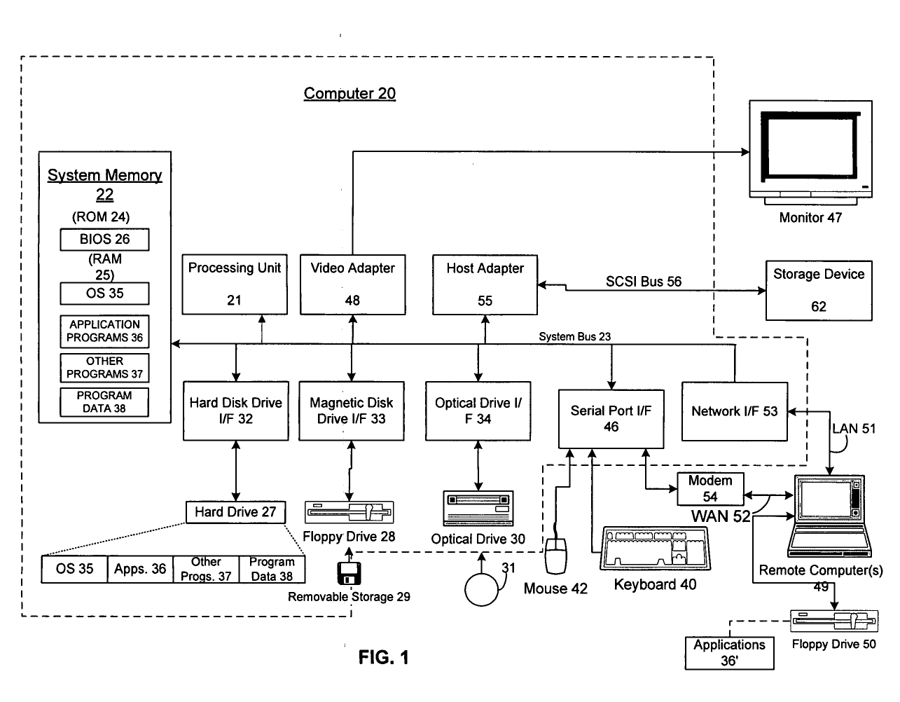

Numerous embodiments of the present disclosure may execute on a computer. FIG. 1 and the following discussion is intended to provide a brief general description of a suitable computing environment in which the disclosure may be implemented. Although not required, the disclosure will be described in the general context of computer executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the disclosure may be practiced with other computer system configurations, including hand held devices, multi processor systems, microprocessor based or programmable consumer electronics, network PCs, minicomputers, mainframe computers and the like. The disclosure may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the personal computer 20, such as during start up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the exemplary operating environment.

A number of program modules may be stored on the hard disk, magnetic disk 29, removable optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise wide computer networks, intranets and the Internet.

When used in a LAN networking environment, the personal computer 20 is connected to the LAN 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

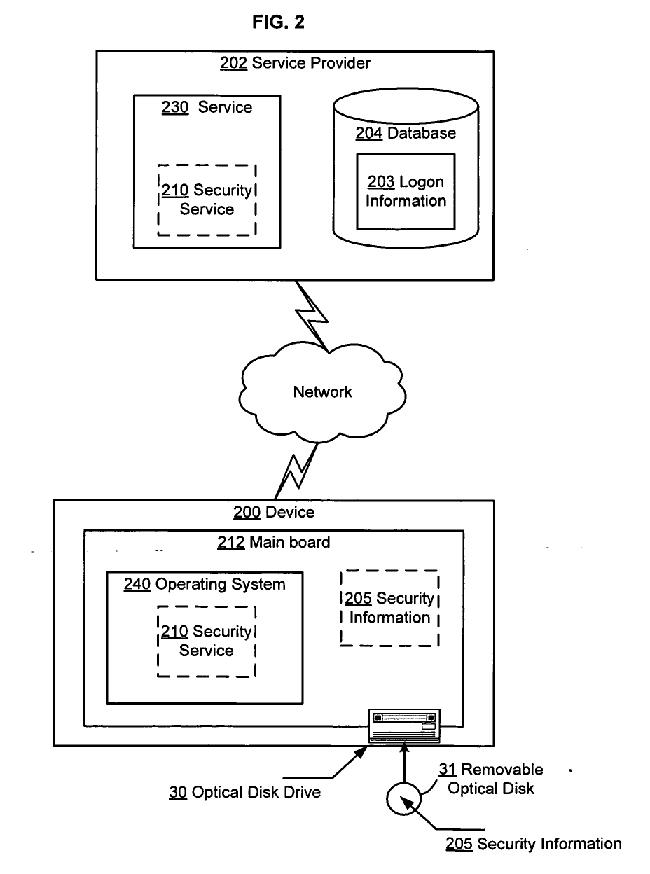

Referring now to FIG. 2, it generally depicts an operational environment for practicing aspects of the present disclosure. As shown by FIG. 2, a service provider 202 can exist that can include one or more services such as service 230. Service 230 can in some instances be a cellular phone service, a data plan service operable to allow a device to connect to a network such as the Internet, a music download service, a movie download service, a ring tone download service, a picture download service, a videogame download service, an online videogame playing service, a premium channel service, etc. In other embodiments the service 230 can include online services such as an internet based email service, an online banking service, an online shopping service, or any other service that requires a user, or device to be authenticated.

Continuing with the description of FIG. 2, in an embodiment of the present disclosure, the service provider 202 can include one or more servers that in turn can include components similar to those found in computer 20 of FIG. 1. The servers can include HTTP servers that can be operatively coupled to backend databases such as relational databases, object oriented databases, column oriented database, etc. As illustrated by FIG. 2, in some embodiments the service provider 202 can be operatively coupled to a device 200 that can include some or all of the aspects of computer 20 of FIG. 1 and will be described in more detail below.

In some embodiments of the present disclosure the service provider 202 can include a security service 210. For example, the security service 210 can in some embodiments include a program that can be executed by a processor and can be configured to challenge any devices that attempt to gain access to the service 230. In a specific example, security service 210 can be an authentication server operable to handle packet based requests for services that include usernames and passwords. In this example, the security service 210 could be configured to search a database of valid usernames/passwords to find one that matches the credentials proffered by the user operating the device 200. In the instance that the username/password matches an entry in the database, the security service 210 can allow the device 200 to access the service 230. As illustrated by FIG. 2, in some instances an implementer may opt to include additional security features and require that a user submit additional credentials additionally or alternatively to username/passwords to access the service 230. For example, when a user is authenticated to use service 230, they may provide the service provider 202 with answers to specific, personal questions, such as their mother's maiden name, the city they were born in, their father's middle name, model type of the first car they owned, etc. In this example, the user operating device 200 that attempts to access services 230 may be prompted to answer one of these specific questions.

As illustrated by the dashed lines in FIG. 2, in some embodiments of the present disclosure the device 200 can be manufactured to include security information 205. For example, the device 200 can in some embodiments be a closed computing system such as a mobile phone, set-top box, videogame console, or the like. During the manufacturing process for the device, the manufacturer can place security information 205 in, for example, read only memory of the device 200, a processor of the device 200, or on the main board of the device 200. In some example embodiments, the security information 205 can be transmitted to the device 200 from the service provider 202 while the device 200 is operating. The service provider 202 in this example embodiment could receive a copy of the security information 205 and the information could be stored in database 204 along with a device identifier. In this example, when a device 200 attempts to access a service 230 offered by a service provider 202 the security service 210 can be configured to challenge the device 200 by transmitting one or more packets of information indicative of a request to read a specific portion of the security information 205 on the device 200 and return a value in a return signal. If an attacker knows that the device 200 contains security information 205, the attacker may try to find the security information 205, or attempt to discover all the questions that a security service 210 will ask in order to build a dictionary. If for example, the security information 205 is encrypted, or digitally signed, the attacker may not be able to modify the information or even view it, however if the attacker is able to create a dictionary of questions and the appropriate answers that a device 200 should reply with, the attacker could modify the system code of the device 200 to include the dictionary and change the security service 210 to read the dictionary instead of reading the actual security information 205.

Continuing with the description of FIG. 2, it shows that device 200 can include a main board 212. In some embodiments of the present disclosure parts can be coupled to, or integrated with the main board 212 such as an optical disk drive 30 that can be configured to read removable optical disk 31, system memory described in FIG. 1, a network adaptor, a processing unit as described in FIG. 1, a video adapter as described in FIG. 1, or any other part that can be coupled to or integrated with a main board 212. The device 200 can include an operating system 240 that can in some embodiments include a security service 210. For example, in some embodiments the operating systems 240 on the device 200 can be configured to manage the hardware connected to the main board 212 and in at least one example the operating system 240 code can include code that effects a security service 210 of device 200. For example, in some instances the security service 210 can operate similarly to the security service 210 of service provider 202, however in other embodiments the security service 210 of device 200 can include code that when executed by a CPU challenges a removable optical disk 31 placed in the optical disk drive 30. In this example when a removable optical disk 31 is inserted into the optical disk drive 30, the security service 210 can be configured to determine if the removable optical disk 31 is authentic and not an unlawful copy before allowing it to play by checking security information (not shown) integrated into the removable optical disk 31.

In order for a security service 210 to be able to challenge a removable optical disk 31 removable optical disk 31 could be manufactured to include security information 205 that can be interrogated by an optical disk drive 30 on behalf of a security service 210 of device 200. For example, a manufacturer can place certain physical or logical imperfections on the removable optical disk 31, or data on the device 200 during its manufacturing process. In the example where disks are manufactured to include imperfections, the imperfections make it difficult to create an exact copy the disk because most commercial disk copiers fix any physical or logical imperfections they encounter in a copying process. Knowing this, attackers may try to discover all the questions that a security service 210 will ask about the physical or logical properties of the removable optical disk 31 in order to build a dictionary. If the attacker is able to create a dictionary of questions and the appropriate answers that a disk should reply with, the attacker could modify the code of the removable optical disk 31 to include the dictionary and release a modified version of the disk that could present the correct answer to a challenge from a security service 210.

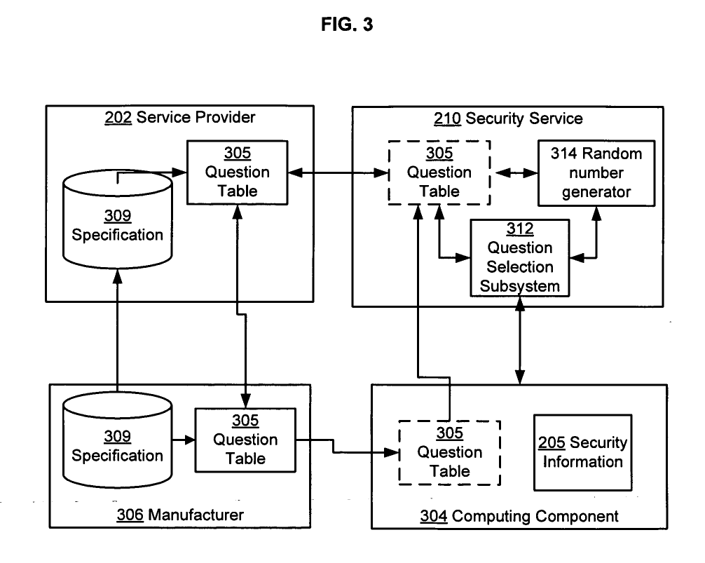

Referring now to FIG. 3, it depicts an example high level operational environment for practicing aspects of the present disclosure. As shown by FIG. 3, in some example embodiments, a security service 210 such as security service in a device 200 or at a service 230 can be configured to challenge a computing component 304 such as the device 200 in some instances, or a removable optical disk 31 in others. As described briefly above, in order to challenge a computing component 304 each computing component 304 may include security information 205 that in some embodiments can be physical or logical properties of the computing component 304, or data. In some embodiments of the present disclosure the security information 205 can be placed in the computing component 304 by a manufacturer 306 during a manufacturing process. For example, the manufacturer 306 of the computing component 304 can produce products such as device 200 and/or removable optical disk 31. In these example embodiments, a service provider 202 can contract with the manufacturer 306 of the removable optical disk 31, or device 200, to manufacturer the computing component 304 to include security information 205. In one specific example, the manufacturer 306 can place logical faults on a removable optical disk 31 of FIG. 2.

Continuing with the description, when the computing component 304 is manufactured, the manufacturer 306 can record where it placed the security information 205 on each computing component 304, and record what values the information should return if they are processed by the security service 210. This information can be compiled by the manufacturer 306 into a specification 309 that describes where the values are placed on the computing component 304 and what the values are. As illustrated by FIG. 3, in some embodiments the manufacturer 306 can use the specification 309 to create a series of security questions that can use the values placed in the computing component 304 to determine whether the computing component 304 is authentic in a security challenge operation. In some embodiments of the present disclosure, a security question could be a request to read a value in memory and return the value. In other embodiments the security question could be a request to check the spacing between two tracks and return the distance. In yet another example, the security question could be a request to obtain a number from a specific sector of a disk and multiply it by the distance between tracks 2 and 4. In other example embodiments, the questions can include questions directed towards read error values on certain sectors of the disk, a number of physical faults in a certain sector of the disk, or any other type of question that the optical disk drive 30 has the means to obtain an answer for. In a specific example, the specification 309 can indicate that a certain sector of an optical disk includes a certain logical fault. A security service 210 of a device 200 can direct the optical disk drive 30 to read a certain portion of the removable optical disk 31 that was manufactured to include the fault. The logical fault can be read and a specific read error value could be obtained by an optical disk drive 30.

For a computing component 304 the specification could describe thousands or millions of features that can be used by either a service provider 202 or a manufacturer 306 to generate a question table 305 that uses the features in security questions. Once a question table 305 is created, a portion of the table or the entire table 305 can be made available to the security service 210 of either the service 230 and/or security service 210 of the device 200. For example and as illustrated by FIG. 3, the security service 210 of either service 230 or a device 200 can be configured to use a subset of the question table 305 or the entire table 305 when selecting security questions to use to challenge a computing component 304. For example, when a service provider 202 obtains a question table 305, the service provider 202 may decide to only use a portion of the table at any one specific time for business related reasons or, for example, the security service 210 may not have enough memory dedicated to storing a copy of the entire table 305. However in other embodiments the security service 210 may be able to obtain the complete question list 305.

In some example embodiments, the security service 210 can be located on a device 200, the security service 210 can obtain a copy of the question table 305 or a subset 305 from a variety of sources. For example, in some example embodiments a subset of the question table 305 can be obtained from the service provider 202 via a network at predetermined times such as once a day, once a week etc. In one specific example, every time, or sometimes when a device 200 connects to a service 230 offered by the service provider 202, the service provider 202 can check to see what portion of the table 305 is stored on the device 200. If a newer portion of the table has been released, the service provider 202 can transmit it to the device 200 and overwrite the older portion. In another example embodiment, the device 200 can obtain a subset of the table 305 from a computing component 304. For example, when the manufacturer 306 creates a removable optical disk 31, it can place a subset of the question table 305 in the computing component 304. In this example embodiment, the security service 210 can be configured to check to see whether the security question table subset 305 stored on the computing component 304 is newer than the subset 305 the security service 210 is currently using. If it is, the security service 210 can be configured to overwrite the older subset of the question table 305 with the newer one. For example, in the instance that a computing component 304 is a removable optical disk 31, removable optical disk 31 can be manufactured to include a subset of the question table 305 and a date indicating how long the subset is valid. For example, disks manufactured between December 2005 and June 2006 could be manufactured to include a certain portion of the table and an indicator indicating how long it is valid, all disks released from July 2006 to November 2006 can include the next portion of the table and a different indicator, and so on and so forth. When a removable optical disk 31 is placed into the optical disk drive 30 the security service 210 can be configured to check to see if the subset table 305′ on the removable optical disk 31 is newer than the table it is using. If the subset on the removable optical disk 31 is newer, the device 200 can copy the table over and use it.

In certain embodiments of the present disclosure, the service provider 202 may only release a portion of the table 305 for various reasons. For example, the space available to store such information can be limited on a device 200 or a removable optical disk 31. For example, the full table 305 can in some instances include millions of questions and answers and the space dedicated to storing a table 305 on the device 200 could only be 1,000 kb. In one instance, the service provider 202 may only release certain portions of the question table 305 to prevent the entire question space from being available to the public. For example, the service provider 202 can maintain a schedule indicating how long certain portions of the question table 305 will be used, and can rotate through the question table 305 by releasing a new portion of the table from time to time. Thus, in some example instances the service provider 202 can slowly release different portions of table 305 over time, and space out the releases such that the life cycle of the disks such as removable optical disk 31, or devices such as device 200 may end before the entire list of possible questions 305 is exhausted. In embodiments where portions of the question table 305 are released over time, an attacker will not be able to cycle through the entire list 305 quickly. Even though in some instances only a portion of the question table 305 may be released at one point in time, an attacker may be able to quickly obtain a dictionary for the released portion. Thus, if the time that it takes an attacker to create a dictionary for a subset of a question table 305 is less than the time in between when the service provider 202 releases a new portion of the table 305, then the removable optical disk 31, or device 200 may be vulnerable for that period of time.

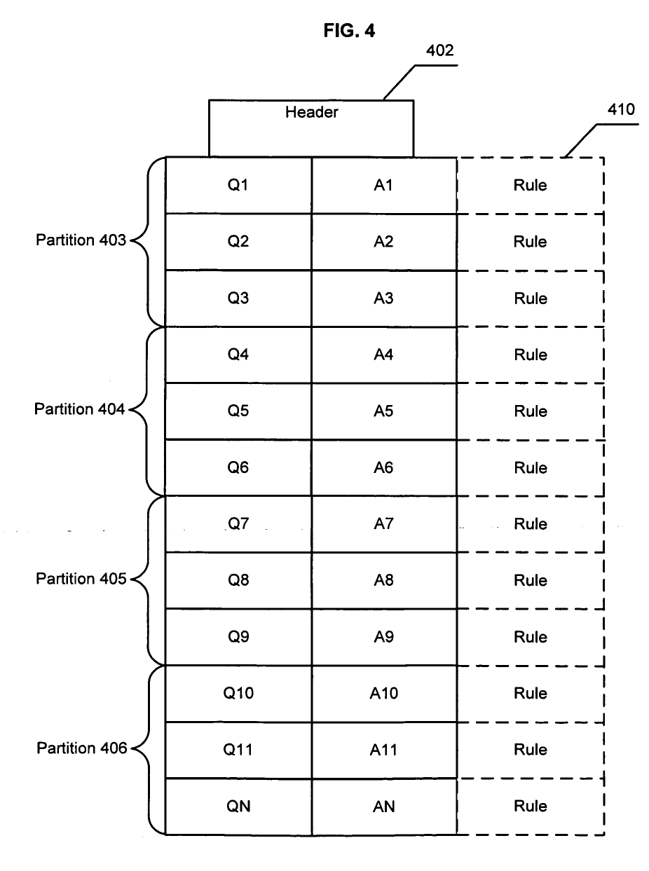

Referring now to FIG. 4, it depicts an example subset of the question table 305 that can be used by a security service 210 in aspects of the present disclosure. As depicted by FIG. 3, in some instances the security service 210 can be configured to use the entire question table 305, or in other example embodiments it can use a subset of the question table 305. In this example, the subset of the question table 305 can be conceptually thought of as a table with N rows where N is an integer greater than 1, and at least two columns, one for a question and one for answer. One skilled in the art will note though that the example subset of the question table 305 is provided to illustrate aspects of the present disclosure, and that the disclosure is not limited to embodiments where security service 210 has access to a subset of the question table 305 that exists as rows and columns. More specifically, the example subset of the question table 305 is depicted as a table including rows and columns to provide a framework that can be easily perceived and understood by one skilled in the art, and the actual implementation of a table that has rows and columns is not necessary. For example, in some embodiments the subset of the question table 305 could exist as data in a relational database, or an object oriented database. Continuing with the description of FIG. 4, in some embodiments of the present disclosure, the question table 305 can be partitioned into multiple groups of questions such partitions 403-406. In some embodiments the partitions 403-406 can be thought of as groups of questions, and while similar types of questions may be part of the same partition in the subset of the question table 305, the groups themselves do not need to have similar questions and questions can be randomly assigned to a partition when the subset of the question table 305 is created.

Continuing with the description of FIG. 4, the subset of the question table 305 can include a header 402 in some embodiments. For example, a header 402 in some instances can include information identifying when the subset of the question table 305 was made accessible to the device 200, or to the security service 210 of a service 230. The header 402 in some embodiments can identify how long the subset of the question table 305 is valid, and in some instances the header may include distribution parameters that can be processed by a question selection subsystem 312 to adjust how an initial partition can be selected from the subset of the question table 305. In some embodiments, a distribution parameter can include information identifying how long a partition such as partitions 403-406 can be used by a question selection subsystem 312 of a security service 210, and/or how many times in a given period can a partition such as partitions 403-406 can be accessed by the security service 210. In other example embodiments, the distribution parameters can include probability values set by, for example, the service provider 202 that indicate how likely a partition 403-406 should be selected, e.g., if a subset of the question table 305 has four partitions such as the subset of the question table 305 of FIG. 4, a distribution parameter could indicate that partition 406 should only be selected 14% of the time.

In some example embodiment of the present disclosure, the question selection subsystem 312 of the security service 210 can be configured to use a distribution parameter that takes into account the current system time as recorded by an internal clock of the device 200, or service 230, and/or the time that the table was made available to the device 200, or the service 230. For example, a subset of table 305 can be made available at times such as one a month, once a year, etc. In one example embodiment the header 402 can include a timestamp that indicates the time that it was made available. The security service 210 can include instructions operable to select initial partitions in accordance with the current time as compared to time the subset of the question table 305 was made available.

In another example, the question selection subsystem 312 can be configured to use a distribution parameter associated with the current number of times questions have previously been selected. For example, each time that a question is selected can be recorded by the security service 210 and each partition in the subset of the question table 305 can be assigned a range of numbers. The question selection subsystem 312 can be configured to obtain the current number of times questions have been selected and find the partition that includes the number in its range. More specifically, in some embodiments the question selection subsystem 312 can be configured to select partition 403 as an initial partition when the current number of questions asked is between 0 and 10, partition 404 when the current number of questions asked is between 11-20, etc. In embodiments where the question selection subsystem 312 can be configured to process distribution parameters that vary how a question selection subsystem 312 is configured, it is less likely that a dictionary attack will quickly obtain all the questions in the subset of the question table 305.

As illustrated by FIG. 4, in some embodiments of the present disclosure the distribution parameters can additionally include arbitrarily complex rules that can provide additional criteria that need to be satisfied before a question row, or partition can be selected by the question selection subsystem 312. In some embodiments of the present disclosure, the arbitrarily complex rule can be stored in the header 402, or stored in a data object that includes a relationship to the subset of the question table 305 or in other embodiments it can be conceptually thought as a third column such as column 410. For example, if a subset of the question table 305 exists with 4 partitions 403-406, one or more of the partitions, or questions could be subject to an arbitrarily complex rule. If the conditions associated with the rule have not occurred, the partition, or question row in the subset of the question table 305 can be locked and the question selection subsystem 312 could be configured to not select it as an initial partition or not select any questions that are locked.

In an example embodiment of the present disclosure, an arbitrarily complex rule could have a probability associated with it. Similar to that described above, when the question selection subsystem 312 is selecting an initial partition it can be configured to use a random number generator 314 to obtain a random number and use it to select an initial partition. In this example, the arbitrarily complex rules could indicate that certain partitions should be selected a certain percentage of times until predetermined criteria occur. More specifically, if a question selection subsystem 312 is configured to calculate what partition to initially use to select questions from, and the conditions associated with a rule for a partition such as partition 404 have not occurred, then the probability of selecting partition 404 as an initial partition could be lower than the probability of selecting partition 405 for example. Since, in most cases dictionaries are not generally compiled by single individuals, but by an association, embodiments that include arbitrarily complex rules can make dictionary attacks more difficult since different arbitrarily complex rules may have been triggered on different devices, causing the question selection subsystem 312 on each device to select questions from different partitions in a subset of the question table 305. In this example, it may be difficult for the association to determine how close they are to completing a dictionary since two attackers may see different sets of challenges.

In some embodiments of the present disclosure, an arbitrarily complex rule can be related to system information, and/or user input, e.g., how many times a user presses a certain button on a controller, that could be recorded by the device 200. In these example embodiments an implementer can take advantage of user input, or system state information to unlock certain partitions or question in a subset of the question table 305, or in other embodiments, modify the probability that a partition, or a question will be selected from a subset of the question table 305. In a specific embodiment, an example rule related to system information could use information such as whether the partition/question logically next to the currently selected partition/question has been selected in the past month/week/day, or whether the device 200 has connected to a service offered by the service provider 202. In other embodiments, a rule could be related to user input such as whether a certain optical disk has been inserted into the optical disk drive 30, whether a user has played a certain movie, song, or game more than a certain amount of times. In a specific example, an implementer could associate a rule with a partition such as partition 406 that requires that a user press the ‘A’ button 10,000 times over the life of the device before the probability that partition 406 will be selected is increased from 2% to a fraction of the total partitions 403-406 in the subset of the question table 305, e.g., in this example 25%. In another specific example, the implementer could associate a rule with a partition such as partition 403 that requires that a user play a certain game for more than 10 hours before partition 403 is available. While an implementer could associate every partition, or every question with an arbitrarily complex rule, in certain embodiments the implementer may only associate certain rows, or partitions in order to maintain a large enough available question base.

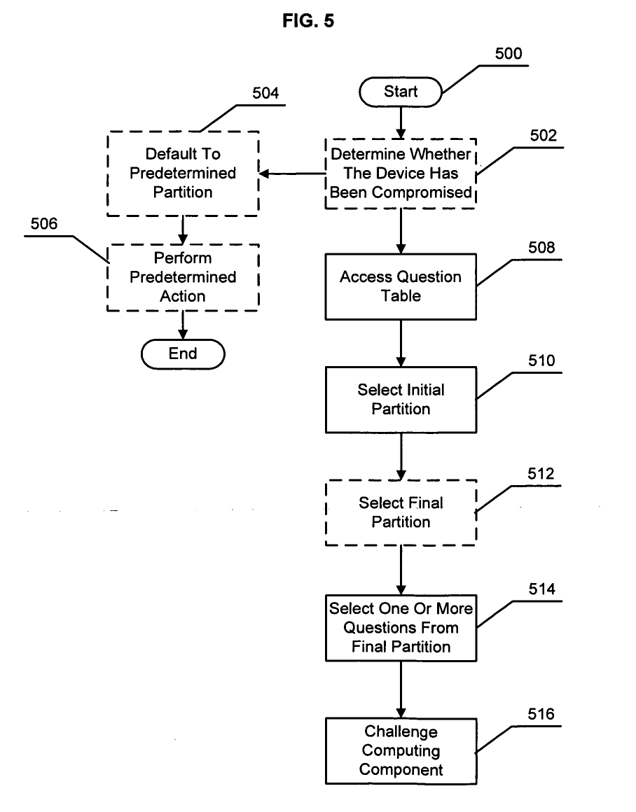

Referring now to FIG. 5 in conjunction with FIG. 2-FIG. 4 depicts an example operational flow chart depicting operational procedures of the present disclosure. Operation 500 begins the operational process, for example, in response to an occurrence of a certain predetermined condition like the insertion of a removable optical disk 31 into the optical disk drive 30, or the connection of the device 200 to a service 230 maintained by service provider 202. In certain operational embodiments, and as shown by operation 502, when the device 200 detects that a removable optical disk 31 has been inserted into the optical disk drive 30, or the security service 210 at the service 230 receives a connection request from the device 200, the security service 210 can be configured to determine whether the device 200 has been modified by an attacker. For example, in some embodiments of the present disclosure, the security service 210 can be configured to monitor the hardware and software running on the device 200, e.g., remotely in some embodiments by monitoring information sent from the device 200 over a network connection, or monitoring locally. In the instance that abnormal behavior is detected, or the state of the device 200 is inconsistent with normal operating parameters, the security service 210 can be configured to determine that the device 200 has been hacked. In this instance, and shown by operation 504, the question selection subsystem 312 can be configured to only select questions from a predetermined partition such as partition 403. In these example embodiments any attacker would only be able to obtain questions from the default partition if the device 200 is compromised and a complete dictionary of questions in question table subset 305′ may not be obtainable. As illustrated by operation 506, in some instances the security service 210 can be configured to perform other operations in response to determining that the device 200 has been modified such as disabling the device 200 and/or sending a signal including its device identifier to the service provider 202 in order to ban the device 200.

Continuing with the description of FIG. 5, and as shown by operation 508, in an example embodiment where the device 200 was not modified, then for example, the question selection subsystem 312 can be configured to access a question table 305, or a subset of the question table 305 to select an initial partition to obtain challenge questions from. For example, in some embodiments of the present disclosure, a function that uses the time that the subset of the question table 305, or question table 305 has been accessible to the security service 210 can be used to determine what partition should be initially selected. For example, the header 402 can include a date that indicates when it was made available and each partition can be assigned a block of time, e.g., partition 403 can be assigned a time block such as days 1-10, and partition 404 can be assigned a time block such as days 11-20. The question selection subsystem 312 can be configured use the availability date of the subset of the question table 305 or question table 305 and the current system time, as calculated by the service 230 or the device 200, to determine what partition to select. For example, if question selection subsystem 312 determines that 5 days have elapsed since the subset of the question table 305 has been made available, then the question selection subsystem 312 can be configured to select partition 403 as the initial partition.

In another example embodiment, the question selection subsystem 312 can be configured to access a question table 305, or a subset of the question table 305 to select an initial partition to obtain a challenge question from by using a random number generator 314. For example, in some embodiments the security service 210 can include a random number generator 314, such as an algorithm that can generate a random or pseudo-random number. In these embodiments, the random number generator 314 can be configured to generate a number between 1 and 100. The question selection subsystem 312 can be configured to map the numbers 1-100 to the different partitions of the subset of the question table 305 or question table 305 and the initial partition can be selected based on the random number. In a specific example embodiment, the question selection subsystem 312 can have access to a table where numbers 1-25 are mapped to partition 403, numbers 26-50 are mapped to partition 404, etc. The random number generator 314 can generate a number such as 30 and the question selection subsystem 312 can select partition 404 as the initial partition. In other embodiments of the present disclosure, the question selection subsystem 312 can access a header 402 of the subset of the question table 305 or question table 305 to obtain one or more distribution parameters that may adjust the mapping between the random numbers generated by the random number generator 314 and the partitions, e.g., the header 402 may indicate that partition 403 is to only be selected 13% of the time so the table can be reconfigured to map numbers 1-13 to partition 403.

Additionally or alternatively, the question selection subsystem 312 can use an arbitrarily complex rule obtained from the header 402 and/or column 410 to adjust the mapping of the partitions. For example in some embodiments of the present disclosure the security service 210 can use additional variables to make the selection process more complex and thus more difficult for a unscrupulous individual to predict. In this case, the question selection subsystem 312 can be configured to use distribution parameters that adjust the probability that certain partitions can be selected by altering the mapping of random numbers to the partitions based on a length of time that is appropriate to using a certain partition, and/or how many times a certain partition can be selected within a period of time.

Similar to that described above, in another implementation of the operational procedure 508, the question selection subsystem 312 can be configured to omit certain partitions from the selection process until conditions associated with arbitrarily complex rules occur. For example, in one embodiment an arbitrarily complex rule could exist that is associated with partition 403. The rule in this example may indicate that the partition should not be available until a user has played a specific videogame, music CD, or used a specific software application for 10 hours. When the security service 210 attempts to challenge a computing component 304, the question selection subsystem 312 can be configured to access information in a header 402 or column 410 to determine how to map random numbers to the subset of the question table 305. Since the condition associated with partition 403 has not occurred in this example, the mapping operation could omit partition 403 and the number mapping for the table can be adjusted in accordance with other distribution parameters if they exist. Once the random number ranges have been mapped to the partitions in the question table 305 or the subset of the question table 305, a random number generating algorithm can produce a random number and the initial partition can be selected.

In some embodiments of the present disclosure, once the initial partition is selected the question selection subsystem 312 can use it as the final partition and select one or more challenge questions from it. In other embodiments, after an initial partition has been selected and as shown by operation 510 a final partition can be selected that can in some embodiments be different than the initial partition. For example, in some instances the random number generator 314 can be used by the question selection subsystem 312 and an initial partition can be selected such as partition 403. The random number generator 314 can be used again and a number between 1 and 100 can be obtained. The question selection subsystem 312 can include a final partition mapping table that can be obtained from the service provider 202, or from the header 402. In some embodiments, the final partition mapping table can be transmitted to the device 200 at predetermined intervals that can be separate then when the subset of the question table 305 is updated, for example. In these example embodiments, the final partition mapping table can in some example embodiments include the numbers 1-100, each number, or a group of numbers can be mapped to a rule that can be used by the question selection subsystem 312 to perform an additional random action to select the final partition. For example, one example final partition mapping table could specify that if the number is between 1 and 90, the final partition is the one chosen in operation 508 for example partition 403. If, however, the random number is between 91-98, the final partition mapping table can indicate that the final partition is the partition immediately following the initially selected partition, partition 404 in this specific example. Finally, if the random number is 99-100 then the final partition mapping table can indicate that the final partition is the partition two partitions after the initially selected partition, partition 405 in this specific example. In some embodiments of the present disclosure, the arbitrarily complex rules can additionally alter the selection of the final partition in optional operation 510. For example, if the random number generated in operation 508 is associated with a table that indicates that the final partition is the following partition, and this partition is associated with an arbitrarily complex rule that has not been triggered, then the question selection subsystem 312 can select the next partition that is available.

As shown by operation 512 and 514, once the final partition has been selected, the question selection subsystem 312 can randomly select an appropriate amount of questions for the final partition in the subset of the question table 305 and challenge the removable optical disk 31 or device 200 one or more times. In certain embodiments of the present disclosure, and described above, the selection of a specific question in a partition can be influenced by the distribution parameters described above. For example, in some instances specific questions can be associated with arbitrarily complex rules and the question selection subsystem 312 can be configured to omit them unless the conditions associated with the rules have occurred.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed:

1. A computer readable storage medium including computer readable instructions for selecting a challenge question, the computer readable storage medium comprising:
instructions for selecting an initial partition in a question set in accordance with a parameter;
instructions for selecting a final partition in the question set in accordance with a randomizing variable and the initially selected partition; and
instructions for challenging a computing component with a question selected from the final partition.

2. The computer readable storage medium of claim 1, further comprising:
instructions for receiving the question set from the computing component.

3. The computer readable storage medium of claim 1, further comprising:
instructions for receiving the question set from a service provider.

4. The computer readable storage medium of claim 1, wherein the plurality of available partitions are selected in accordance with an arbitrarily complex rule.

5. The computer readable storage medium of claim 1, further comprising:
instructions for determining that a device has been modified; and
instructions for selecting a predetermined partition from the question set as the final partition.

6. The computer readable storage medium of claim 1, wherein the parameter indicates valid time periods for the partitions in the plurality.

7. The computer readable storage medium of claim 1, wherein the question set is a subset of a larger question set.

8. The computer readable storage medium of claim 1, wherein the parameter uses information that identifies how long the question set has been available.

9. A computing system operable to determine whether optical disks are authentic, the computing system comprising:
an optical disk drive operable to receive a disk;
a memory location operable to store a question set, the question set partitioned into at least a plurality of available groups;
a processor configured to select an initial question group from the plurality of available groups in accordance with a length of time the question set has been stored in memory;
the processor further configured to use randomizing criteria on the selected initial question group to select a final question group;
the processor further configured to select a question related to a property of the disk from the final group; and
the processor further configured to determine whether the disk includes the property.

10. The computing system of claim 9, wherein the question set was received from the disk.

11. The computing system of claim 9, further comprising:
the processor further configured to generate the plurality of available groups from the question set prior to selecting the initial question group in accordance with an arbitrarily complex rule.

12. The computing system of claim 11, wherein the arbitrarily complex rule is related to user input.

13. The computing system of claim 11, wherein the arbitrarily complex rule prevents a specific group of the plurality of groups from being available until a predetermined condition has occurred.

14. The computing system of claim 11, wherein the arbitrarily complex rule reduces the probability that a specific group of the plurality will be selected as an initial partition until a predetermined condition has occurred.

15. The computing system of claim 9, wherein the processor is further configured to select an initial question group from the plurality of groups in accordance with a number of times the processor has selected questions.

16. A method for challenging a disk, comprising:
receiving, by a device, a disk;
accessing a table of available question partitions of a question set;
using a first criteria to select an initial question partition from the available question partitions; wherein the criteria is related to a length of time the question set has been stored on the device;
using a second criteria and the initial question partition to select a final question partition from the available question partitions;
selecting a question from the final question partition; and
using the selected question to determine whether the disk is authentic.

17. The method of claim 16, further comprising:
comparing a question set on the disk to the current question set; and
copying the question set from the disk when the question set on the disk is newer than the current question set.

18. The method of claim 16, further comprising:
generating the table of available question partitions from a question set in accordance with an arbitrarily complex rule.

19. The method of claim 16, wherein determining the authenticity of the disk further comprises checking a physical property of the disk.

20. The method of claim 16, wherein the question is selected in accordance with an arbitrarily complex rule associated with a question in the final question partition.
